(19) United States
(12) Patent Application Publication
(10) Pub. No.: US 2006/0004786 A1
(43) Pub. Date: Jan. 5, 2006

(54) Design mechanism for semiconductor fab-wide data warehouse application

(75) Inventors: Shun-An Chen, Sinshih Township (TW); Shinn-Chih Wang, Cihtong Township (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company Ltd., Hsin-Chu (TW)

(21) Appl. No.: 10/862,207

(22) Filed: Jun. 7, 2004

(51) Int. Cl. G06F 17/00

(52) U.S. Cl. 707/100

(57) ABSTRACT

A method and system for collecting, storing and accessing semiconductor manufacturing data in a storage entity are provided. The semiconductor manufacturing data is collected from at least one process tool and stored in a first predefined area of the storage entity until the data storing in the first predefined area is complete, at which time additional semiconductor manufacturing data may be stored in a second predefined area of the storage entity. After the storing of data in the first predefined area is complete, it may be accessed.

### BACKGROUND

The present disclosure relates generally to the field of semiconductor product manufacturing and, more particularly, to a system and method for semiconductor manufacturing data warehousing and data management.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations needed to produce an IC may be performed at different locations by a single company or by different companies that specialize in a particular area. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

A semiconductor fabrication facility may have many different processes occurring simultaneously on a twenty-four hour, seven days per week schedule. Complete automation of product identification, product tracking, process status, process control, equipment control, and equipment status are necessary in order to effectively run a semiconductor fabrication facility. Many problems may occur during a process flow for a semiconductor product ranging from equipment problems, process problems, and facilities problems. Simple errors such as mis-processing of a product or plurality thereof may occur due to a misjudgment or other errors in the process flow of a product line.

Accordingly, what is needed is a system and method to provide a semiconductor manufacturing data warehouse with efficient insertion and retrieval of data to manufacturing equipment and processes.

### BRIEF DESCRIPTION OF THE DRAWINGS

FIG. 1 depicts a semiconductor manufacturing data warehouse system with efficient retrieval and insertion of data to manufacturing equipment and processes.

FIG. 2 depicts an example virtual integrated circuit fabrication system for implementing one embodiment of the present disclosure.

FIG. 3 depicts a more detailed example of the virtual integrated circuit fabrication system of FIG. 2.

FIG. 4 depicts an example computer system that may be used in a virtual integrated circuit fabrication system such as described in FIGS. 2 and 3.

FIG. 5 is another embodiment of the semiconductor manufacturing data warehouse system of FIG. 1.

FIG. 6 illustrates a more detailed example of the system of FIG. 5.

FIG. 7 is a flowchart for query of data from the database for a specified date.

FIG. 8 provides sample code for executing the query of FIG. 6.

### DETAILED DESCRIPTION

The present disclosure relates generally to the field of semiconductor manufacturing and, more particularly, to a system and method for providing a semiconductor manufacturing data warehouse with efficient retrieval and insertion of data to manufacturing equipment and processes. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

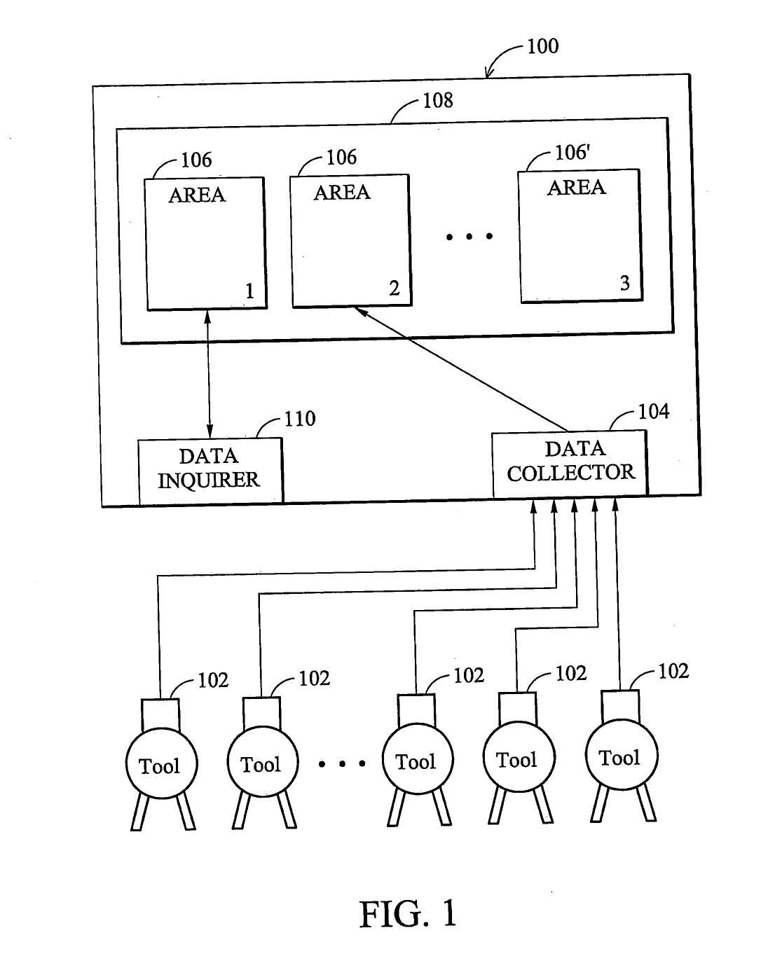

Referring to FIG. 1, in one embodiment, a semiconductor manufacturing data warehouse system 100 with efficient insertion and retrieval of data from manufacturing equipment and processes is shown. System 100 collects data from at least one process tool 102 through data collector 104. Process tool(s) 102 may include any type of semiconductor or industrial type of manufacturing system that may perform a specified set of tasks that may help to fabricate a product. Process tool(s) 102 may include metrology equipment that may be used to gather data from a product such as material compositions, film thickness, surface contamination, dimensional measurements, and any other variable that may be measured by a metrology tool. Process tool(s) 102 may include metrology equipment as a sub-component of a cluster tool where a plurality of processes may be executed by a single process tool.

Data collector 104 stores the data collected from process tool(s) 102 into predefined areas 106 in storage entity 108. Data is stored in a first predefined area until the data storage is complete for such predefined area, at which time data storage for the next predefined area begins. The predefined areas may be defined by various factors. For example, the predefined areas may be associated with data collected for a period of time (for example, a day or a week), number of lots process by a tool, or a storage area size. Once the data storage for a predefined area 106 is complete, data may be accessed from such predefined area at any time by a data inquirer 110 independent from the data collection and storing conducted by data collector 104.

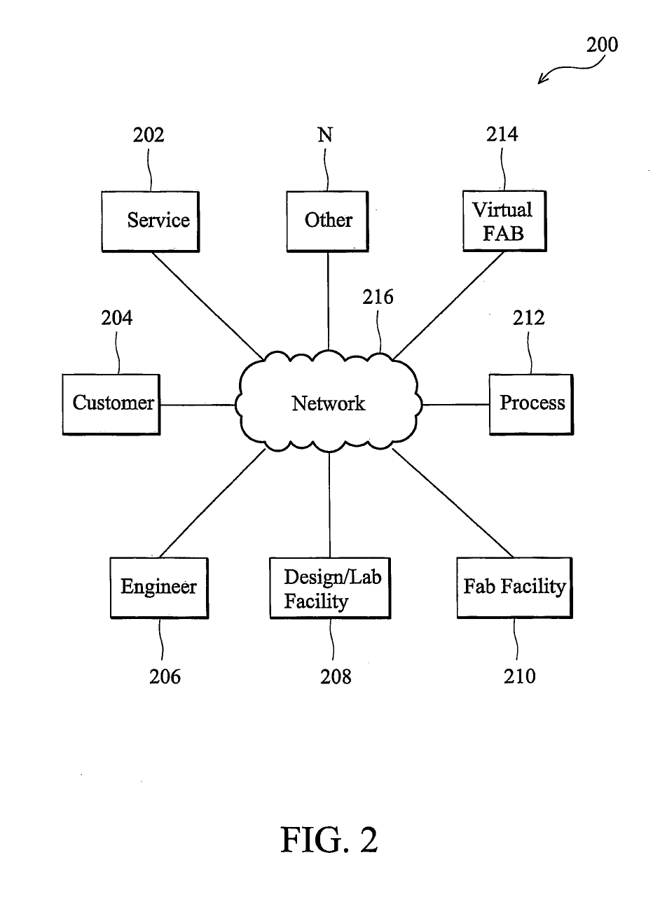

Referring now to FIG. 2, a virtual IC fabrication system (a “virtual fab”) 200 is one example of a system within which the data warehousing system of FIG. 1 may be used. The virtual fab 200 includes a plurality of entities 202, 204, 206, 208, 210, 212, 214, . . . , N that are connected by a communications network 216. The network 216 may be a single network or may be a variety of different networks, such as an intranet and the Internet, and may include both wireline and wireless communication channels.

In virtual fab 200, the entity 202 represents a service system for service collaboration and provision, the entity 204 represents a customer, the entity 206 represents an engineer, the entity 208 represents a design/laboratory (lab) facility for IC design and testing, the entity 210 represents a fabrication (fab) facility, the entity 212 represents a process (e.g., an automated fabrication process), and the entity 214 represents another virtual fab (e.g., a virtual fab belonging to a subsidiary or a business partner). Each entity may interact with other entities and may provide services to and/or receive services from the other entities.

For purposes of illustration, each entity 202-212 may be referred to as an internal entity (e.g., the engineer 202 or the system process 212) that forms a portion of the virtual fab 200 or may be referred to as an external entity (e.g., the customer 204) that interacts with the virtual fab 200. Some entities may be both internal and external. For example, customer 204 may provide updated mask sets (internal) and may purchase the final products/services (external) also. It is understood that the entities 202-212 may be concentrated at a single location or may be distributed, and that some entities may be incorporated into other entities. In addition, each entity 202-212 may be associated with system identification information that allows access to information within the system to be controlled based upon authority levels associated with each entities identification information.

The virtual fab 200 enables interaction among the entities 202-212 for the purpose of IC manufacturing, as well as the provision of services. In the present example, IC manufacturing includes receiving a customer's IC order and the associated operations needed to produce the ordered ICs and send them to the customer 204, such as the design, fabrication, testing, and shipping of the ICs.

One of the services provided by the virtual fab 200 may enable collaboration and information access in such areas as design, engineering, and logistics. For example, in the design area, the customer 204 may be given access to information and tools related to the design of their product via the service system 202. The tools may enable the customer 204 to perform yield enhancement analyses, view layout information, and obtain similar information. In the engineering area, the engineer 206 may collaborate with other engineers using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

Another service provided by the virtual fab 200 may integrate systems between facilities, such as between the design/lab facility 208 and the fab facility 210. Such integration enables facilities to coordinate their activities. For example, integrating the design/lab facility 208 and the fab facility 210 may enable design information to be incorporated more efficiently into the fabrication process, and may enable data from the fabrication process to be returned to the design/lab facility 210 for evaluation and incorporation into later versions of an IC. The process 212 may represent any process operating within the virtual fab 200.

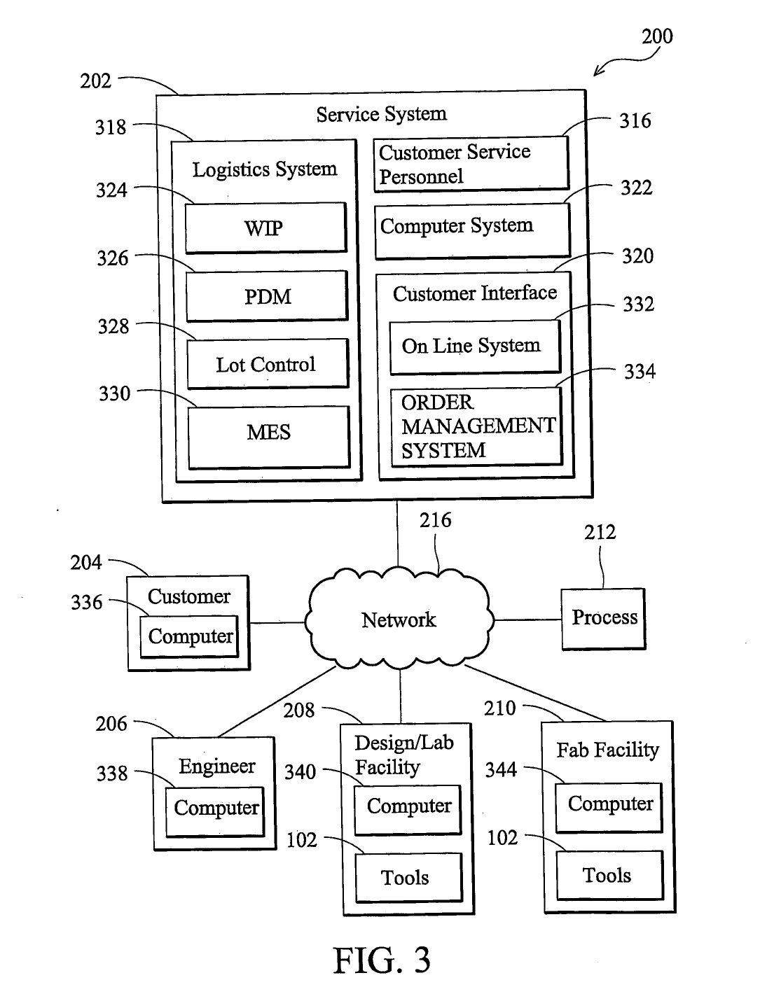

Referring now to FIG. 3, in another embodiment of the virtual fab 200, the entities 202-212 are described in greater detail. The service system 202 provides an interface between the customer and the IC manufacturing operations. For example, the service system 202 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database. The product data management system 326 may manage product data and maintain product information in a product database. The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 202 and outside of the service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system 334. The online system 332 may function as an interface to communicate with the customer 204, other systems within the service system 202, supporting databases (not shown), and other entities 306-312. The order management system 334 may manage client orders and may be associated with a supporting database (not shown) to maintain client information and associated order information.

Portions of the service system 202, such as the customer interface 320 and order management system 334 may be associated with a computer system 322. In some embodiments, the computer system 322 may include multiple computers, some of which may operate as servers to provide services to the customer 204 or other entities. The service system 202 may also provide such services as identification validation and access control, both to prevent unauthorized users from accessing data and to ensure that an authorized customer may access only their own data.

The customer 204 may obtain information about the manufacturing of its ICs via the virtual fab 300 using a computer system 336. In the present example, the customer 204 may access the various entities 202, 204-212, of the virtual fab 200 through the customer interface 320 provided by the service system 202. However, in some situations, it may be desirable to enable the customer 204 to access other entities without going through the customer interface 320. For example, the customer 204 may directly access the fab facility 210 to obtain fabrication related data.

The engineer 206 may collaborate in the IC manufacturing process with other entities of the virtual fab 200 using a computer system 338. The virtual fab 200 enables the engineer 206 to collaborate with other engineers and the design/lab facility 208 in IC design and testing, to monitor fabrication processes at the fab facility 210, and to obtain information regarding test runs, yields, etc. In some embodiments, the engineer 206 may communicate directly with the customer 204 via the virtual fab 200 to address design issues and other concerns.

The design/lab facility 208 provides IC design and testing services that may be accessed by other entities via the virtual fab 200. The design/lab facility 208 may include a computer system 340 and various IC design and testing tools 102. The IC design and testing tools 102 may include both software and hardware.

The fab facility 210 enables the fabrication of ICs. Control of various aspects of the fabrication process, as well as data collected during the fabrication process, may be accessed via the virtual fab 200. The fab facility 210 may include a computer system 344 and various fabrication hardware and software tools and equipment 102. For example, the fab facility 210 may include an ion implantation tool, a chemical vapor deposition tool, a thermal oxidation tool, a sputtering tool, and various optical imaging systems, as well as the software needed to control these components.

The process 212 may represent any process or operation that occurs within the virtual fab 200. For example, the process 212 may be an order process that receives an IC order from the customer 204 via the service system 202, a fabrication process that runs within the fab facility 210, a design process executed by the engineer 206 using the design/lab facility 208, or a communications protocol that facilities communications between the various entities 202-212.

It is understood that the entities 202-212 of the virtual fab 200, as well as their described interconnections, are for purposes of illustration only. For example, it is envisioned that more or fewer entities, both internal and external, may exist within the virtual fab 300, and that some entities may be incorporated into other entities or distributed. For example, the service system 202 may be distributed among the various entities 206-210.

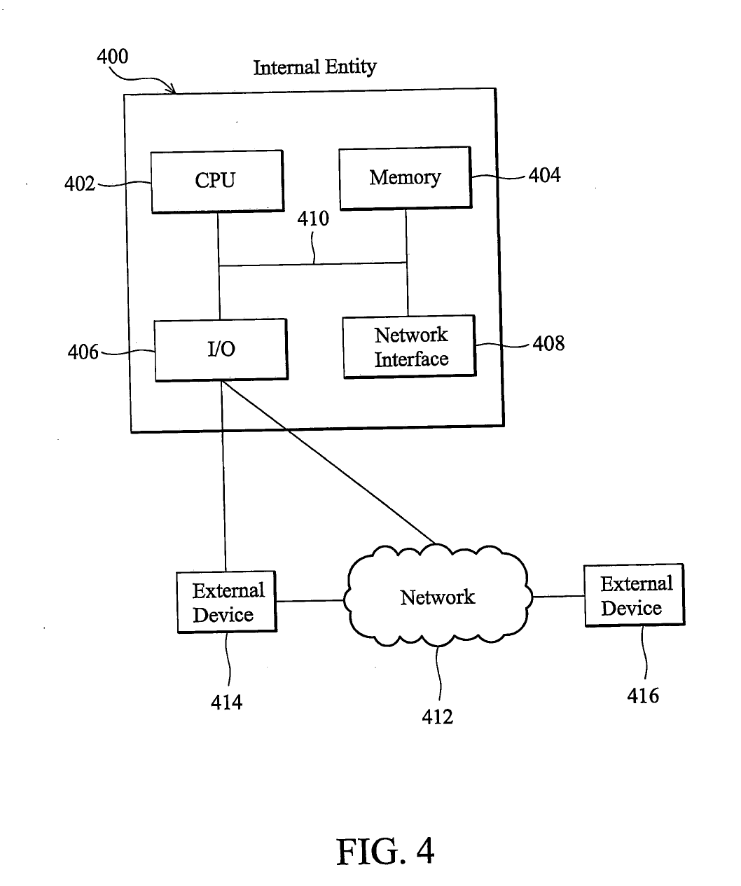

Referring now to FIG. 4, an exemplary computer 400 may be used to implement one or more portions of the embodiments, including the implementation of the semiconductor manufacturing data warehousing system 100 through MES 330 in virtual fab 200. The computer 400 may include a central processing unit (CPU) 402, a memory unit 404, an input/output (I/O) device 406, and a network interface 408. The network interface may be, for example, one or more network interface cards (NICs). The components 402, 404, 406, and 408 are interconnected by a bus system 410. It is understood that the computer may be differently configured and that each of the listed components may actually represent several different components. For example, the CPU 402 may actually represent a multi-processor or a distributed processing system; the memory unit 404 may include different levels of cache memory, main memory, hard disks, and remote storage locations; and the I/O device 406 may include monitors, keyboards, and the like.

The computer 400 may be connected to a network 412, which may be connected to the networks 216 (FIGS. 2, 3). The network 412 may be, for example, a complete network or a subnet of a local area network, a company wide intranet, and/or the Internet. The computer 400 may be identified on the network 412 by an address or a combination of addresses, such as a media control access (MAC) address associated with the network interface 408 and an internet protocol (IP) address. Because the computer 400 may be connected to the network 412, certain components may, at times, be shared with other devices 414, 416. Therefore, a wide range of flexibility is anticipated in the configuration of the computer. Furthermore, it is understood that, in some implementations, the computer 400 may act as a server to other devices 414, 416. The devices 414, 416 may be computers, personal data assistants, wired or cellular telephones, or any other device able to communicate with the computer 400.

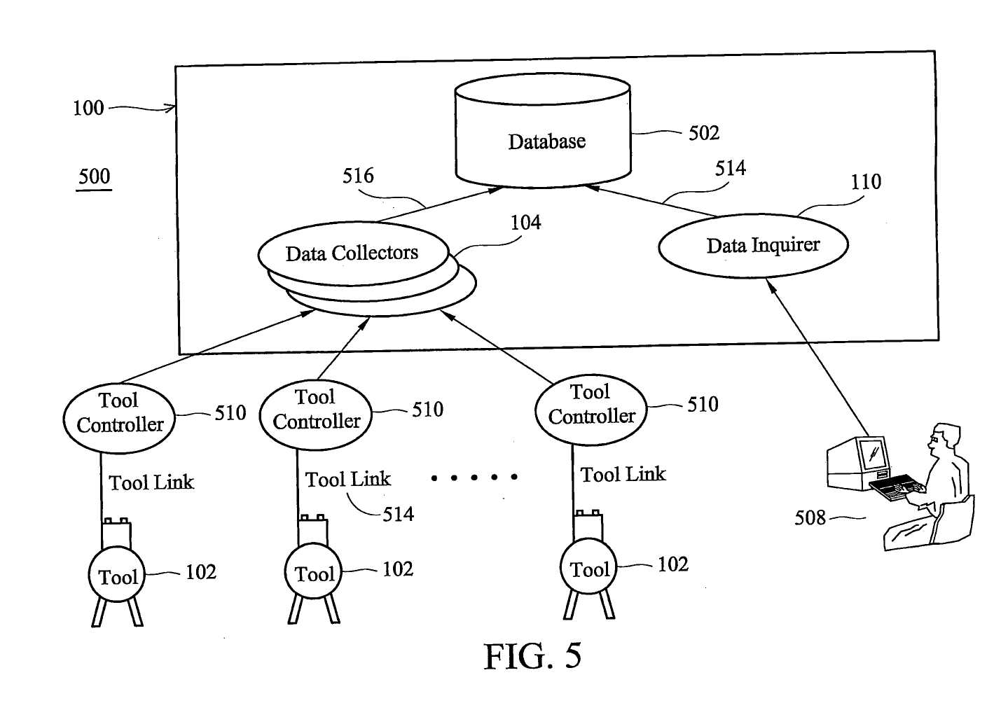

Referring now to FIG. 5, a system 500 is a more detailed embodiment of data warrehouse system 100 for collecting data from any location in virtual fab 200, which utilizes computer integrated manufacturing (CIM). CIM is the term used to describe the automation of a semiconductor manufacturing facility, with all processes functioning under computer control and digital information tying them together. An example CIM implementation may include computer-aided design/computer-aided manufacturing equipment, computer-aided process planning capabilities, computer numerical control machine tools, direct numerical control machine tools, flexible machining systems, automated storage and retrieval systems, automated guided vehicles, use of robotics and automated conveyance, computerized scheduling and production control business systems and an MES.

In the present embodiment, storage entity 108 may include a MES 330 database 502. Database 502 may be configured to receive enormous amounts of data, such as data from process tool(s) 102, product information, process information, product test information, user input information, and any other information or data that may be recorded. Database 502 may be configured to be continually being updated.

Process tool(s) 102 may include any type of semiconductor or industrial type of manufacturing system that may perform a specified set of tasks that may help to fabricate a product. For example, a process tool 102 may be a tool in design/lab facility 208 or a fab facility 210. Therefore, in the case of semiconductor fabrication where many different material layers are stacked upon each other, a plurality of layers along with a plurality of measurements may be executed by a process tool(s) 102.

Generally, there may be three major considerations for CIM system design, which may include the reduction of cross-influence of data inquiry and data insertion into a database 502, the efficiency of the response time for data insertion, and the efficiency of the response time for data inquiry. The present embodiment employs a relational database as database 502 utilizing sequential query language (SQL) to communicate with a database 502. According to ANSI (American National Standards Institute), SQL is the standard language for relational database management systems. SQL statements are used to perform tasks such as update data on a database, or retrieve data from a database. Some common relational database management systems that use SQL are produced or distributed by several companies, such as Oracle Corporation of Redwood Shores, California, Sybase Inc. of California, IBM Corporation of New York, and Microsoft Corporation of Washington. Database 502 may be implement on any hardware with sufficient capacity. Some example platforms capable of being used with the systems that use SQL mentioned above are Window NT, Unix platforms or OpenVMS platforms, all available from Hewlett-Packard Company of California.

The present embodiment may provide separate database channels coupled to database 502 for data insertion and data inquiry; data inquirer 514 or a plurality thereof and data insertion channel 516 or a plurality thereof. In one embodiment, the data collectors 104 may build a plurality of sequential query language (SQL) commands by employing a bind variables technique. Bind variables improves performance, wherein a SQL command (An SQL command included: query, insert and update) may be prepared once and executed multiple times, without loosing data associated with the SQL command. The bind variables technique may join together a plurality of associated variables, files, and other clusters of information. For example, bind variables techniques may provide a lookup table and/or cache wherein all associated entities of a variable may reside closely linked to a variable, file, query, and/or any other clusters of information. The use of bind variables improves the cache-hit rate of SQL command for database 502, which may have a cache prepared prior to the creation of the queries. Database 502, which supports the bind variables may parse the SQL command by substituting input bind variables into parsed code created at a prior time. If the same SQL command executes a plurality of times, then even with different values for the input bind variables, database 502 may have the code cached. Therefore, further parsing of the SQL command may not be required. However, if the input bind variables are not employed, then database 502 may parse the SQL command each time wherein every access of the database may be slightly different each time. Furthermore, the code for every interaction with the database 502 may be slightly different for each SQL command which may result in congestion of the cache.

A plurality of smaller tables or caches with links to various variables may be employed to enhance the loading rate of SQL parsing information and the execution of a SQL command. The plurality of data collectors 104 and lookup data tables may effectively increase data insertion due to the small file size and linkage to various variables. In addition, in the present embodiment, the data table are divided into data groups. The data may be grouped by time (for example, for a fixed interval of time) or by some other characteristic (for example storage size, lot number, etc.).

Of course, it is understood that the use of the SQL command is not limited, and that other commands, queries, and/or other information manipulation commands may be employed associated with the data collectors 104, the database 502, and/or other entities.

The data collectors 104 may collect process data from a plurality of tool controller(s) 510 connected to process tool(s) 102 or collect process data directly from a plurality of process tool(s) 102 (stand-alone or clusters). For example, a parent data collector 104 may be assigned to a plurality of etch process, diffusion, thin film, or lithography process tool(s) 102. Other data collectors 104 may be assigned to electrical probing and test systems. Data collectors 104 may be assigned to specific time intervals for data collection to a specific process tool 102. Alternatively, the data collectors 104 may be assigned for each process tool 102 and may be coupled to a database 502 for a plurality of process tool(s) 102 through the virtual fab.

The tool controller 510 may be implemented in many forms. For example, tool controller 510 may be a system that resides in a computer integrated into a process tool 102 or may exist as a sub-component of a system providing supporting control for the process tool 102. Data from the tool controller 510 may be sent to the data collectors 104 at a specified time or after a specified number of product pieces or semiconductor wafers have been processed by a process tool(s) 102. Data collection by the tool controller(s) 510 and the data collectors 104 may occur sequentially, in parallel, and may be distributed asymmetrically throughout the virtual fab.

The time in which data may be sent from the tool controller 510 to the data collectors 104 may be event driven. For example, data could be sent from the tool controller 510 to the data collectors 104 after a process is complete for a single wafer or after a lot of wafers. In the case of a cluster of process tool(s) 102 where a plurality of processes may be combined into a single process equipment platform, data may be sent to the data collectors 104 from the tool controller 510 partitioned by process chamber on the cluster of process tool(s) 102 and/or the data maybe grouped according to all processes that may be combined in a cluster of process tool(s) 102. The tool controller 510 and plurality thereof may collect and store process and equipment data for each lot, semiconductor wafer, or process piece. After each process in a process tool 102, the data controller 510 may send data to the data collectors 104. The tool controller 510 may record any and all information from a process tool 102 at any specified interval of time. The data uploaded from the tool controller 510 may be automatically and continuously grouped according to time by the data collectors 104. The tool controller 510 may buffer or store any data from any process tool(s) 102 until an event triggers the tool controller 510 to transmit or download the data to the data collectors 104. Buffering the data is useful, but not essential. The tool controller 510 may normalize any data collected from the process tool(s) 102 until all data from a lot, wafer, or processing piece may be completely processed by the process tool(s) 102. Normalizing the data with respect to a plurality of baseline data may help to reduce the size of the data and, therefore, further speedup the ability to access the data from the tool controllers 510 to the data collectors 104. Normalized data may be of smaller size and, therefore, allows for quick read and write operations between the tool controller 510 and the process tool(s) 102.

Still referring to FIG. 5, access to the database 502 may be accomplished through the data inquirer 110, which may be accessed by a controller 508, either of which may be accomplished via remote access. A plurality of data inquirers 110 may be utilized. The at least two separate database channels 514 and 516, one for data collection and one for data inquiry, allow for simultaneous, continuous parallel processing of process tool(s) 102 data collection and data inquirer 110.

Tool controller 510 and process tool(s) 102 may be connected or linked by a tool link 514. The tool link 514 may include a standard communication protocol known as the Semiconductor Equipment Communication Standard (SECS) or may be linked by any other suitable communications method. Other methods of communication between process tool(s) 102, the tool controllers 510, and the data collectors 104 may be through wireless protocols such as Bluetooth™ and IEEE 902.11 b, for example. Wireless communication protocols may be also employed by all components of the database 500 system, including database 502, data collectors 104, the data inquirer 110 and the remote server 508.

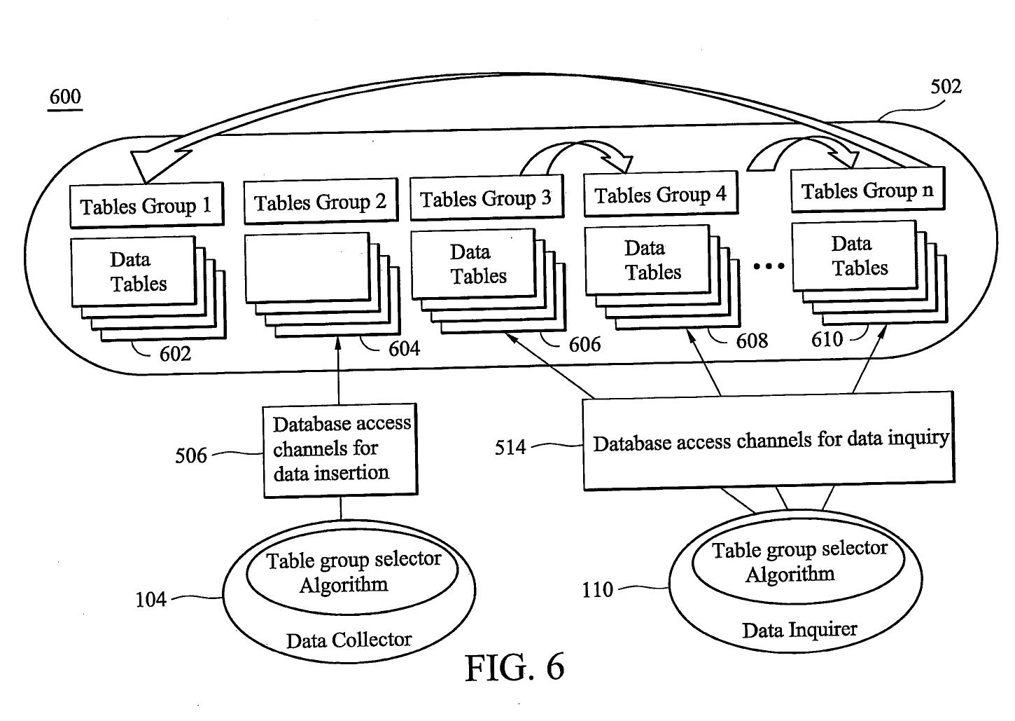

Referring now to FIG. 6, system 600 illustrates the partitioning of database 502 into plurality of data tables 602, 604, 606, 608, and 610. Data inquirer 110 may access the data tables 602-610. The data tables 602-610 may be grouped in numerous ways, including a specified time period. Partitioning collected data into a plurality of small data tables 602-610 may significantly increase the speed at which data may be accessed for analysis. All data during a specified time period that may correspond to specified data tables 602-610 may be saved in the same data tables 602-610 for a specified time.

In systems 500 and 600, data inquirer 110 may process in parallel with the data collectors 104. The finite amount of storage space in the database, organized in data groups, reduces the impact of backing up data in database 502, because backing up and/or purging the data may be executed on a data group basis instead of on the entire database. For example, the table group storing the oldest data may be backed up and/or purged to prepare it for storing data during the next period. Therefore, a data group may be backed up and/or purged instead of backing up and/or purging all the data in the database to get free space. Also, the small data tables 602-610 allow for all operations including those in data collectors 104 and data inquirers 110 to be processed at very fast speeds, since small files are generally quicker and easier to process.

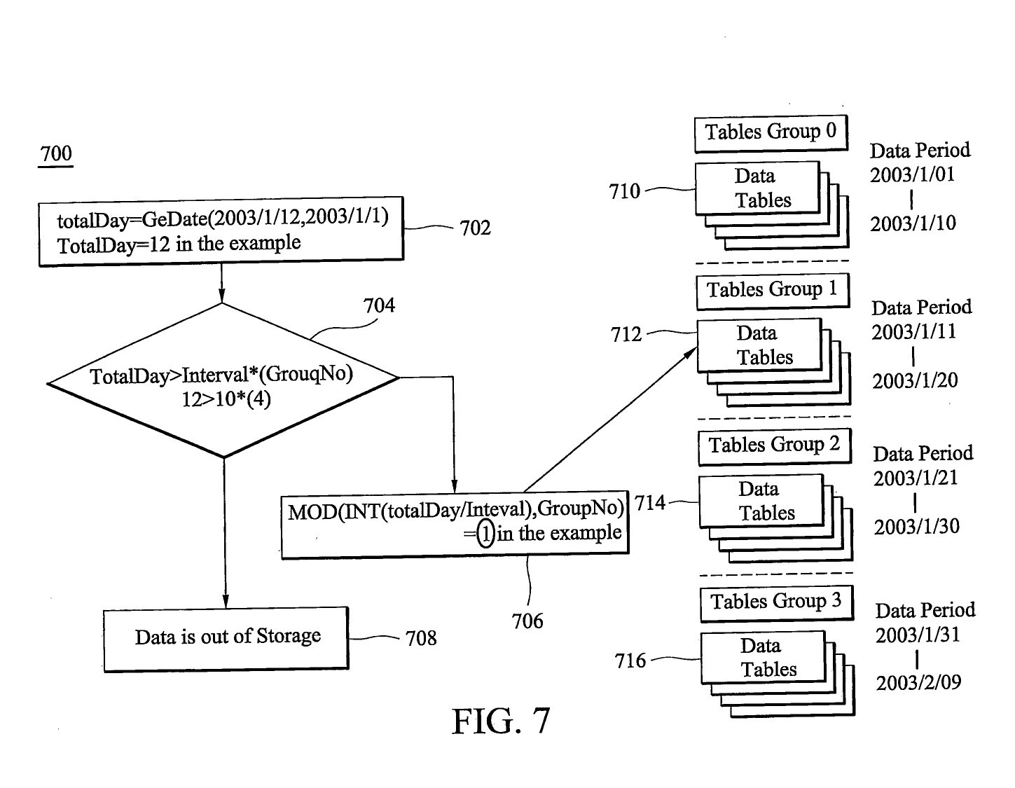

Referring now to FIG. 7, flowchart 700 provides an example process for determining the location of data associated with a specific date. For purpose of example only, it is assumed that data is being stored for a period of forty (40) days. Collected data is stored in a database in data tables, which are arranged into table groups. The variable “GroupNo” represents the number of table groups. In this example, there are four (4) table groups; “Table Group 0” 710, “Table Group 1” 712, “Table Group 2” 714 and “Table Group 3” 716. Each table group includes ten (10) days worth of data organized in ten (10) data tables, one for each day. The number of days per table group is represents by the “Interval” variable. In this example the Interval is ten (10)).

To illustrate the process for determining the table group associated with data collected for a specific date (“Data Date”), the Data Date is Jan. 12, 2003 and the data collection initiation date is Jan. 1, 2003 (“Start Date”). Step 702 defines a “TotalDay” variable as the total number of days of data stored in database 502 since the Start Date. In the example, TotalDay is twelve (12) days. Decision 704 determines whether any data corresponding to the Data Date exists in the table groups by comparing the value of the TotalDay variable to the Interval multiplied by the GroupNo. If the value of the TotalDay variable is greater than the Interval multiplied by the GroupNo and, thus, the no corresponding data exists in the table groups, then the user may be notified of such and may access back-up data or take any other action in step 708.

If the value of the TotalDay variable is less than or equal to the Interval multiplied by the GroupNo, then data is available for access and step 706 is executed to determine the table group associated with the Data Date. Step 706 utilizes the following: (1) the MOD or modulus function that returns the remainder when one number is divided by another; and (2) INT function that rounds a number down to the nearest integer. In the current example, in the MOD function, the devisor is the GroupNo variable and the numerator is the result of the INT function on TotalDay variable divided by the Interval variable. In this example, the result of the MOD function calculation is “1” representing “Table Group 1” 712. If data from another date is desired, the process shown in flowchart 700 may be repeated.

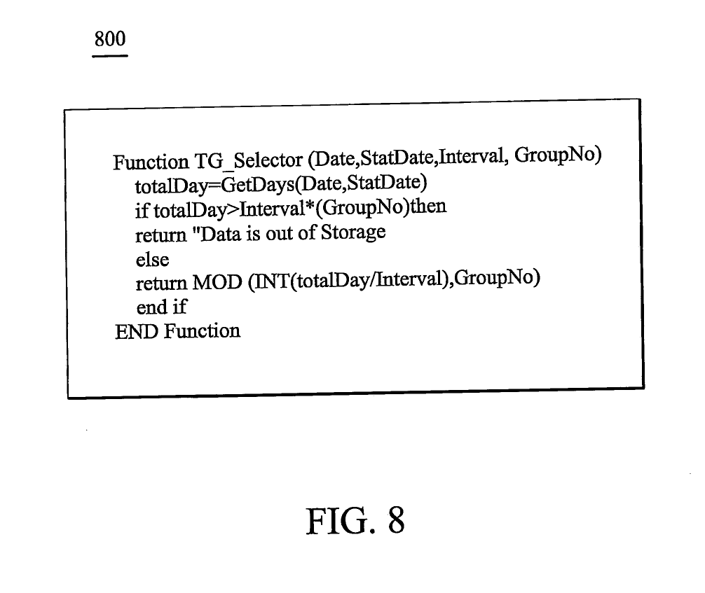

FIG. 8 provides an example routine 800 for executing the process determining the table group associated with data for a specific date shown in steps 702, 704, 706 and 708 of flowchart 700.

FIGS. 7 and 8 are representative example embodiments. Depending on the type and volume of data, the number of tables may vary and the existence or number of table groups may vary as well. The process shown in FIG. 7 may be modified to accommodate the storing of data in certain data table or data groups.

Thus, the present disclosure provides a method for collecting, storing and accessing semiconductor manufacturing data in a storage entity. The method may include the collection of semiconductor manufacturing data from at least one process tool, storing it in a first predefined area of the storage entity until the storing of semiconductor manufacturing data in the first predefined area is complete. Then additional semiconductor manufacturing data may be stored in a second predefined area of the storage entity after the storing of semiconductor manufacturing data in the first predefined area is complete. After the storing of semiconductor manufacturing data in the first predefined area, the semiconductor manufacturing data in the first predefined area of in the storage entity may be accessed without interfering with the storing of the additional data.

In another embodiment, the present disclosure provides a computer-readable medium having stored thereon sequences of instruction for responding to a request for collecting, storing and accessing semiconductor manufacturing data in a storage entity is disclosed. The sequence of instructions may include instructions for performing the steps of collecting the semiconductor manufacturing data from at least one process tool and storing it in a first predetermined area in the storage entity until the storing of semiconductor manufacturing data in the first predefined area. Additional semiconductor manufacturing data may be stored in a second predefined area of the storage entity after the completion of storing of semiconductor manufacturing data in the first predefined area. After the completion of the storing of semiconductor manufacturing data in the first predefined area, the semiconductor manufacturing data in the first predefined area of in the storage entity may be accessed without interfering with the storing of the additional data in the second predetermined area.

The present disclosure also provides a system for collecting, storing and accessing semiconductor manufacturing data from at least one process tool in a storage entity is disclosed. The system may include a storage entity having at least two predetermined areas for storing data. The system may also include a data collector connected to the storage entity, and configured to receive semiconductor manufacturing data from at least one process tool, and to store the data in the at least two predetermined areas. The system may further include a data inquirer connected to the storage entity to access the semiconductor manufacturing data in each predetermined area in the storage entity after the storing of semiconductor manufacturing data each predefined area is complete.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

What is claimed is:

1. A method for collecting, storing and accessing semiconductor manufacturing data in a storage entity, the method comprising:
collecting the semiconductor manufacturing data from at least one process tool;
storing the semiconductor manufacturing data in a first predefined area of the storage entity until the storing of semiconductor manufacturing data in the first predefined area is complete;
accessing subsequently the semiconductor manufacturing data in the first predefined area of the storage entity; and
storing additional semiconductor manufacturing data in a second predefined area of the storage entity after the storing of semiconductor manufacturing data in the first predefined area is complete.

2. The method of claim 1, wherein the storage entity is a database.

3. The method of claim 1, additionally comprising the step of:
collecting the semiconductor manufacturing data from at least one process tool for a predetermined period prior to storing.

4. The method of claim 3, wherein the predetermined period represents a period for processing a single lot of wafers by the process tool.

5. The method of claim 1, further comprising the step of:
normalizing the semiconductor manufacturing data from the at least one process tool prior to storing it in the storage entity.

6. The method of claim 1, further comprising the step of:
storing the semiconductor manufacturing data from the at least one process tool in a data collector utilizing bind variables prior to storing it in the storage entity.

7. The method of claim 1, wherein the first predefined area and the second predefined area are data tables.

8. The method of claim 7, further comprising the step of:
organizing the data tables into data groups.

9. The method of claim 8, further comprising the step of:
determining a data group associated with data stored for a predetermined date; and
accessing data from the data group associated with data stored for the predetermined date.

10. A computer-readable medium having stored thereon sequences of instructions for responding to a request for collecting, storing and accessing semiconductor manufacturing data in a storage entity, the sequence of instructions including instructions for performing the steps of:
collecting the semiconductor manufacturing data from at least one process tool;
storing the semiconductor manufacturing data in a first predefined area of the storage entity until the storing of semiconductor manufacturing data in the first predefined area is complete;
accessing subsequently the semiconductor manufacturing data in the first predefined area of the storage entity; and
storing additional semiconductor manufacturing data in a second predefined area of the storage entity after the storing of semiconductor manufacturing data in the first predefined area is complete.

11. The computer-readable medium of claim 10, wherein the storage entity is a database.

12. The computer-readable medium of claim 10, further comprising the step of:
collecting the semiconductor manufacturing data from at least one process tool for a predetermined period prior to storing.

13. The computer-readable medium of claim 12, wherein the predetermined period represents a period for processing a single lot of wafers by the process tool.

14. The computer-readable medium of claim 10, further comprising the step of:
normalizing the semiconductor manufacturing data from the at least one process tool prior to storing it in the storage entity.

15. The computer-readable medium of claim 10, further comprising the step of:
storing the semiconductor manufacturing data from the at least one process tool in a data collector utilizing bind variables prior to storing it in the storage entity.

16. The computer-readable medium of claim 10, wherein the first predefined area and the second predefined area are data tables.

17. The computer-readable medium of claim 16, further comprising the step of:
organizing the data tables into data groups.

18. The computer-readable medium of claim 17, further comprising the step of:
determining data group associated with data stored for a predetermined date; and
accessing data from the data group associated with data stored for the predetermined date.

19. A system for collecting, storing and accessing semiconductor manufacturing data from at least one process tool in a storage entity, the system comprising:
a storage entity having at least two predetermined areas for storing data;
a data collector configured to receive semiconductor manufacturing data from at least one process tool and store the data in the at least two predetermined areas in the storage entity; and
a data inquirer connected to the storage entity to access the semiconductor manufacturing data in each predetermined area in the storage entity after the storing of semiconductor manufacturing data in each predefined area is complete.

20. The system of claim 19, wherein the storage entity is a database.

21. The system of claim 19, wherein the data collector collects the semiconductor manufacturing data for a predetermined period of time prior to storing the semiconductor manufacturing data in the storage entity.

22. The system of claim 21, wherein the predetermined period of time represents a period for processing a single lot of wafers by the process tool.

23. The system of claim 19, wherein the data collector normalizes the semiconductor manufacturing data from the at least one process tool prior to storing it in the storage entity.

24. The system of claim 19, wherein the data collector utilizes bind variables in the collection and storing of the semiconductor manufacturing data from the at least one process tool.

25. The system of claim 19, wherein at least two predetermined areas for storing data are data tables.

26. The system of claim 25, wherein the data tables are organized into data groups.
